(19) United States
(12) Patent Application Publication
(10) Pub. No.: US 2010/0174698 A1
(43) Pub. Date: Jul. 8, 2010

(54) METHOD FOR A CUSTOMIZED AND AUTOMATED FORWARD AND BACKWARD PATENT CITATION SEARCH

(75) Inventors: David E. Odland, Scottsdale, AZ (US); Kathryn P. Odland, Scottsdale, AZ (US); Justin Seth Kniep, Chandler, AZ (US); Angela Christina Stigen, Mesa, AZ (US); Zheng Rong, Phoenix, AZ (US); Jan Maurice Allen, Tempe, AZ (US); Jaric Enin Loving, Scottsdale, AZ (US)

Correspondence Address: Global Patent Solutions LLC, 7632 E. Stetson Drive, Suite 203, Scottsdale, AZ, 85251, US

(73) Assignee: GLOBAL PATENT SOLUTIONS, LLC, Scottsdale, AZ (US)

(21) Appl. No.: 12/349,466

(22) Filed: Jan. 6, 2009

(51) Int. Cl. G06F 7/06; G06F 17/30

(52) U.S. Cl. 707/706; 707/E17.014

(57) ABSTRACT

The present invention relates to a method for efficiently searching a patent database using patent search software. A target patent or group of patents are identified and utilized through a forward and backward citation search (FNB search) to identify patent references closely related to the patent search subject. The FNB search may be customized by a plurality of user selectable options to manipulate the results of the FNB search, and the results may be output in a variety of formats depending on the preferences of the user.

### FIELD OF INVENTION

The present application relates generally to searching patent databases and more particularly to a method for searching the patents cited, citing patents and cited non-patent literature for a designated target patent or group of patents references.

### BACKGROUND

Patent searching has become very valuable for parties involved with obtaining, owning or establishing the rights to inventions. There are a number of different types of patent searches. The following is a list and description of some examples of patent searches which have been provided solely for discussing the various embodiments of the invention, and are not meant to either directly or indirectly limit the spirit and scope of the embodiments of the invention:

1. A Patentability/Novelty Search—This type of search is typically performed prior to writing, filing and/or fully prosecuting a patent application and is based upon an existing invention prototype or concept comprising the subject for which an inventor may be pursuing a patent. The results of a patentability/novelty search can provide insight as to whether an invention may be patentable, and may assist in determining the potential value of a patent or the scope of the claims of the patent application. A patentability/novelty search may cover any combination of the following: U.S. Patents, U.S. Published Applications, International (PCT/WO) Publications, Foreign Patents, Foreign Publications, and Non-Patent Literature.

2. Freedom-to-Operate Search/Infringement/Clearance—This type of search typically focuses on the claims of non-expired U.S. and/or Foreign patents and published applications in which the claims may preclude the manufacture, use, or sale of an invention which is unprotected by a patent. The party seeking a freedom-to-operate/infringement/clearance search typically is not looking to obtain patent rights for their invention, but rather seeking assurance that someone else does not have a patent claiming the same subject matter.

3. State-of-the-Art/Collection—This type of search is a broad search covering a general inventive concept or general idea. A state-of-the-art/collection search does not require specific details of the invention and it “paints-a-picture” of the existing public information relating to the inventive concept. A state-of-the-art/collection search provides valuable insight into patentable niches, product liability and investment opportunities. A state-of-the-art/collection search may cover any combination of the following: U.S. Patents, U.S. Published Applications, International (PCT/WO) Publications, Foreign Patents, Foreign Publications, and Non-Patent Literature.

4. Validity/Invalidity—This type of search is used to determine if specific claims of a particular subject patent are valid or invalid. A validity/invalidity search may also provide insight into the value of the patent and possible licensing opportunities. A validity/invalidity search is usually focused on prior art having a priority date that precedes the priority date of the subject patent. A validity/invalidity search may cover any combination of the following: U.S. Patents, U.S. Published Applications, International (PCT/WO) Publications, Foreign Patents, Foreign Publications, and Non-Patent Literature.

Conducting searches in a patent database for the most relevant art is a time consuming process where a premium is set on efficiency in order to meet deadlines imposed by filing requirements, litigation, or a variety of other reasons. Additionally, some of the publically available databases may have limited Boolean logic whereby it is difficult to narrow search queries to manageable results sets without being excessively limiting. One way to conduct a patent search and uncover relevant art involves indentifying a relevant reference or set of references and performing a forward and backward citation search (hereinafter, FNB search) of the reference or set of references.

An FNB search involves first identifying a target patent or group of patents. From this target patent or group of patents, a collection of patents can be uncovered that usually has a close relation to the technology of the target patent or group of patents. The patents cited on the face of the target patent by the patent issuing authority comprise the “backward” patents and will usually have priority dates preceding the target patent. FIG. 4 uses a U.S. patent to illustrate a References Cited section 401 of a target patent which includes U.S. and foreign patent documents, and an Other Publications section 403 which includes non-patent literature. For a U.S. patent, the citations listed in sections 401 and 403 of the target patent are usually provided by the Examiner in a Notice of References Cited (USPTO Form 892) and/or the Applicant for the patent in an Information Disclosure Statement (USPTO Form 1449). While the References Cited 401 are considered “backward” patents because they are provided prior to the issue date of the target patent, the “forward” patents comprise subsequent or more recent patents in which the target patent is the one cited in the Reference Cited section 401 of these subsequent patents. These subsequent citing patents are considered “forward” patents because they will typically have priority dates after the target patent. With the citations listed in the References Cited 401 section of a patent usually being provided by the Applicant and/or the Examiner of a patent application, an FNB search takes advantage of the prior searching performed by the Applicant and Examiner to produce a collection of references that are usually highly relevant or in similar technology areas to the patent search.

Presently, there is not an efficient method of conducting an FNB search using search software. The time spent manually retrieving citations for an FNB search by the user is often better used in other tasks. Patent analysis software exists to help identify relationships between patents and relevant assignees for licensing purposes, but these programs lack the ability to customize an FNB search for the purposes of a patent search. In a patent search, efficiency is paramount due to cost and deadlines imposed by a variety of reasons such as filing requirements, litigation dates, etc. The ability to automatically generate a manipulated results set of forward and backward citations increases the probability that the most relevant art will be reviewed in the quickest amount of time. This invention proposes a solution through a method to generate a customized FNB search results set in an automated manner.

### SUMMARY

The present invention relates to a method for efficiently generating a search strategy when searching a patent database using patent search software. A target patent or group of patents are identified and a forward and backward citation search (FNB search) is performed on that target patent or group of patents to identify other references that may be closely related to the subject of the patent search. The FNB search may be customized by a plurality of user selectable options to manipulate the results of the FNB search. The user selectable options include but are not limited to reducing or expanding results by patent issuing authorities, highest priority patent family member, critical date, previously reviewed references in the patent search, level of depth, keywords and/or patent classification. The results may be output in a variety of formats depending on the preferences of the user, including but not limited to a listing of citations, graphical representation, relevance indication or a separate query. An additional embodiment provides a preview of the unrestricted FNB results for a target patent or group of patents.

### BRIEF DESCRIPTION OF THE FIGURES

The object, features and advantages of the present invention will become more apparent by describing the preferred embodiments with reference to the accompanying figures, in which:

FIG. 1 is a flow diagram outlining the steps in the method of the first embodiment for conducting a customized forward and backward citation search.

FIG. 2 illustrates the various options that may be selected by the user to customize the forward and backward citation search.

FIG. 3 is a flow diagram outlining the steps in the method of the second embodiment for a Preview forward and backward citation search.

FIG. 4 illustrates the References Cited, Related Application Data, and Other Publications portions on the face of a U.S. Patent.

FIG. 5 illustrates the levels of depth in a forward and backward citation search.

FIG. 6 illustrates an example of a menu displaying a plurality of user selectable options for a forward and backward citation search.

### DETAILED DESCRIPTION

1. Definitions

The following terms are used throughout the disclosure as defined below:

Target patent/group of patents—the patent(s) or published patent application(s) (pre-grant publications) that have been identified by the user as of interest and provide the starting point for a forward and backward citation search.

Subject Patent—the patent(s) or pre-grant publication(s) that is/are the subject of the patent search, such as the patent in a validity/invalidity type search, and that provides the subject matter to be searched.

Forward and Backward Citation Search (FNB search)—a search that compiles patents cited, citing patents and/or cited non-patent literature citations for a target patent or group of patents.

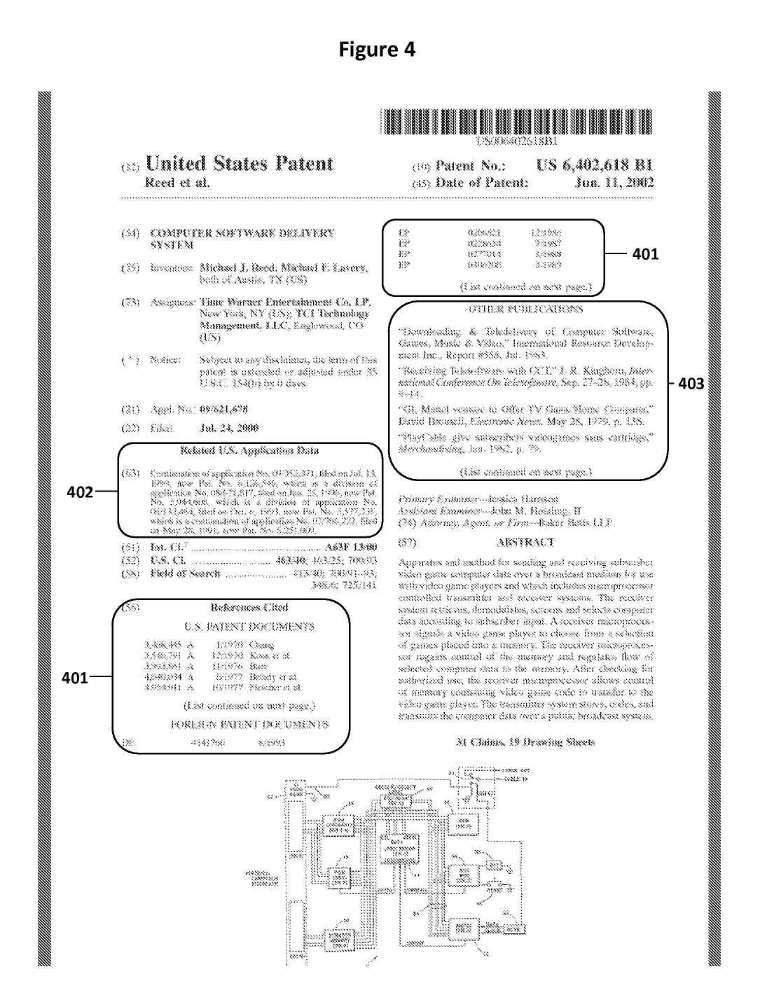

Patents Cited—patents, published applications (pre-grant publications) and/or PCT/WO publications cited on the face of the target patent or associated documents, such as the “References Cited” section 401 as shown in FIG. 4.

Citing Patents—subsequent patents, published applications and/or PCT/WO publications which cite the target patent on the face of the subsequent patent or associated documents, such as in the “References Cited” section 401 as shown in FIG. 4.

Non-Patent Literature—any published literature, such as journal articles, websites, brochures, operator's manuals, etc., that discusses patentable subject matter but is not a patent or pre-grant publication. One example is illustrated by the U.S. patent “Other Publications” section 403 in FIG. 4.

Patent Family Member—for any patent, family members include but are not limited to other related patents or publications that result from provisional applications, reissue patents, continuations, continuations-in-part, related foreign documents (i.e. PCT/WO documents and/or foreign patents or publications), and/or divisional applications that all have common priority claims and at least some common subject matter, such as the references listed in the Related Application Data section 402 of FIG. 4.

Patent Database—a structured collection of patent and published application records, and associated information including patent bibliographic data, such as patents cited, citing patents, and cited non-patent literature that is stored in a computer system or other computer readable memory where the relational data structures can be stored, queried, and retrieved.

Additional Action by the User—copying and pasting, or other known methods of manually retrieving citation information including but not limited to methods that require steps of formatting the retrieved information.

Citation—text identifying a document, including a patent, pre-grant publication, or non-patent literature, which may be selected to allow the user access to the full document and the document's associated information.

Reference—the full document and associated information for a patent, pre-grant publication or non-patent literature.

Activation Means—any known method, such as a mouse-button click, positioning the mouse pointer in a certain location, etc., to reveal a drop-down menu, pop-up, menu, information box, window or other visual means displaying information.

Pre-Grant Publication—patent applications that are published and may be from any patenting authority including US and foreign patenting authorities.

2. Customizable FNB

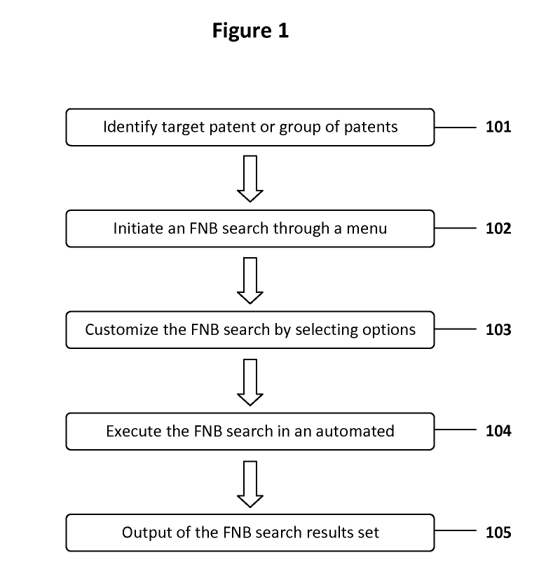

The preferred embodiment describes a method of conducting an FNB search within a patent search software program that displays pages on the user's computer desktop, or other known electronic data processing device. The search software may be web based, a desktop application, or any other known method of document searching. FIG. 1 illustrates a flow diagram outlining the steps in the method for conducting a customizable, automated FNB search in a patent database that contains a structured collection of patent and pre-grant publication records with associated patents cited, citing patents, and cited non-patent literature information for each reference in the database. The first step 101 involves identifying the target patents or group of patents that the user would like as the starting point for an FNB search. Identifying the target patent or group of patents may include any means of selecting the patent or group of patents, including but not limited to a check box next to the reference citations, using activation means on the patent citations, entering the patent citation numbers into a query box, or other known methods of identifying references in a database for a search.

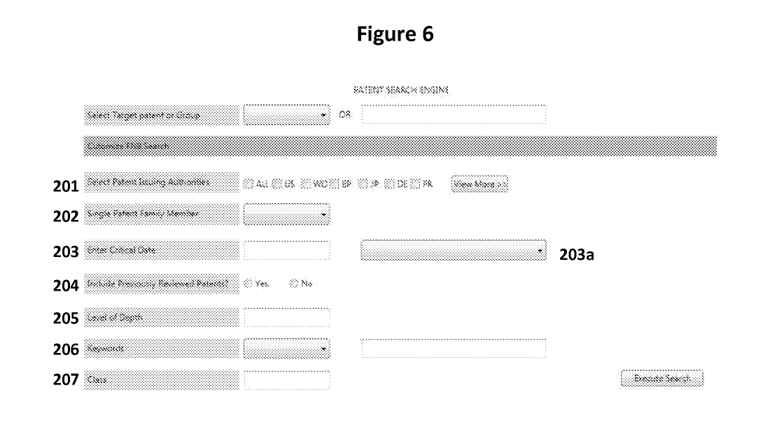

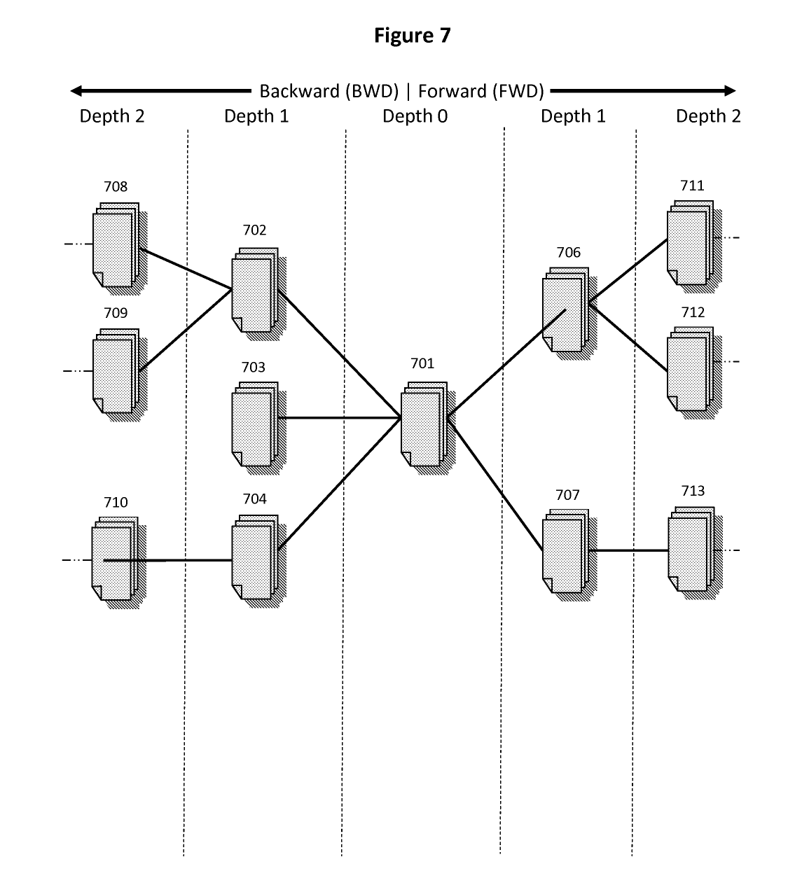

The next step 102 involves initiating an FNB search through a menu. The initiation may occur through any number of means, including but not limited to a drop down menu on the page, a separate FNB search menu page, such as illustrated in FIG. 6, or a menu revealed by using activation means on the current page. Once the user initiates an FNB search the user may customize the search through a plurality of options within the menu in step 103.

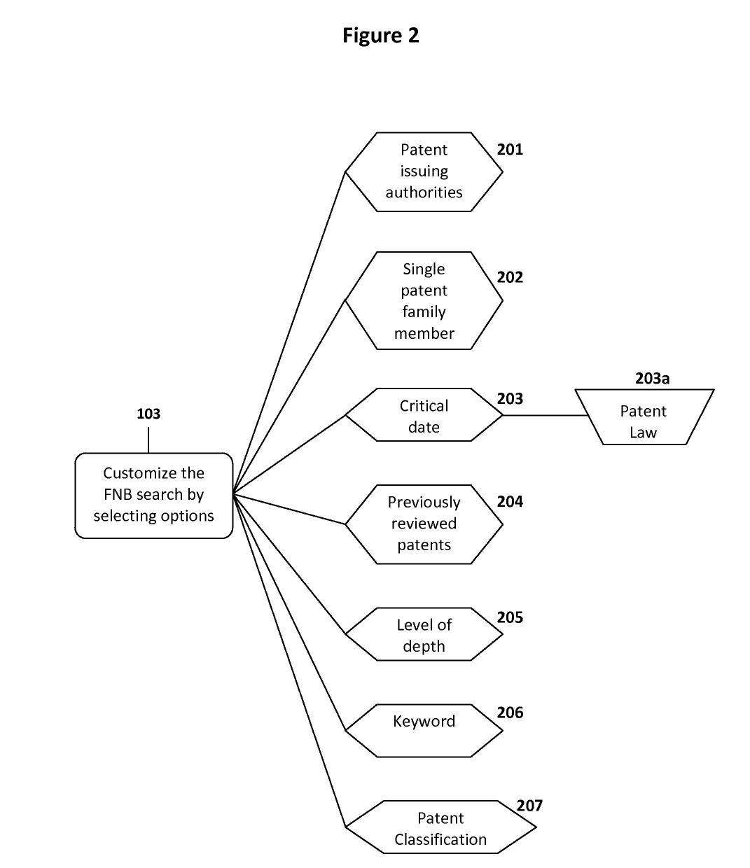

The third step 103 provides the user the ability to customize an FNB search through options that will manipulate the results set, or the user may choose to conduct an FNB search without restriction by not selecting any of the options. FIGS. 2 and 6 illustrate the plurality of options available to the user at step 103 to maximize the efficiency of the search. The first available option 201 allows the user to select one or more patent issuing authorities will be included in the results set. Examples of the patent issuing authorities include but are not limited to the United States (US), Europe (EP), Great Britain (GB), Japan (JP), World Intellectual Property Organization (WO), Germany (DE), France (FR), Canada (CA), etc. There may also be an option to select all issuing authorities. The advantage provided by the patent issuing authorities' option is it allows the user to expand the results set to include references from all available issuing authorities or focus the results on a particular issuing authority or group of issuing authorities of interest to the user.

The second available option 202 allows the user to reduce the results set to the single highest priority family member of each patent family in the results set. One example of patent family members is illustrated by the U.S. patent in FIG. 4. The patent in FIG. 4 shows other U.S. family members (continuations, continuations-in-part, divisional, etc.) on its face in a section titled Related U.S. Application Data 402. The user may define which family member is of the highest priority based on publication dates, issuing authorities, a reference that has been previously reviewed by the user, and/or other criteria important to the specific search. Further, when reducing the results set to a single highest priority family member the software may bucket, track, highlight or otherwise indicate the other family members in a side window, side pane, clickable tree structure, subsequent search queries for review at a later time, or other known visual means. Additionally, if activation means are used with a citation, the patent family members of the citation may be revealed in a manner such as a menu, information box, window, pane, or other visual means wherein further manipulation of the displayed set may be performed.

One example illustrating the advantage of indicating the associated family members in a separate visual means would occur in an FNB search of reference X where the user limits the results set to a single highest priority family member and the user is reviewing the list of citations. If the user utilizes activation means with a citation, then a menu or other visual means will indicate the list of family members associated with the citation. This allows the user to save the list as a separate search query, which may be limited by date, keyword or any other data manipulation. The saved list of the patent family members may be beneficial to searches, such as Freedom-to-Operate, where it is desired to review the claims of each member of the patent family in a separate query.

The option of limiting the results set to the single highest priority patent family member also provides the advantage of reducing the number of references in the results that have similar and/or redundant disclosures. Some patents may have tens or hundreds of family members having the same specification, and depending upon the type of search, removing duplicate disclosures may be an efficient use of time. With a reduced results set, a more comprehensive search may be completed because more time can be allocated to identifying different, non-related references as opposed to reviewing duplicate information.

The third available option 203 allows the user to reduce the results set in relation to a critical date. In certain searches, such as validity/invalidity searches, the user is focused on reviewing references that precede the priority date of the subject patent. Similarly, in a freedom-to-operate search the user may be focused on unexpired patents. Therefore, excluding references that fall outside of the relevant date range for the subject patent not only saves the user time by limiting the number of references to review, but also avoids the error of the user reviewing and possibly citing references outside of the desired date range. The critical date option 203 excludes references by allowing the user to define the critical date or range of dates for the results set. Depending on the user's preference and the type of search, the user may define the critical date further with sub-option 203a as the publication date, filing date, U.S. priority date, foreign priority date, or other relevant date as defined by U.S. legislation, such as 35 U.S.C. §102(a), (b) and/or (e), any other rules and laws under Title 35 of the United States Code, or the laws of any other worldwide patenting authority. For example, the user may be presented with a menu that provides a selectable option of “35 USC 102(e)”. In that case, the software would be programmed to automatically determine and provide results sets that would qualify as prior art under 35 USC 102(e). Thus, if the user was unfamiliar with all the intricacies of 35 USC 102(e), the software would determine the appropriate results for the user. This method of further defining of the critical date of the search may be applied to all patent issuing authorities, or applied differently for individual patent issuing authorities or groups of patent issuing authorities in the search.

One example demonstrating when critical date option 203 and sub-option 203a would provide an advantage to the user would be in a validity/invalidity search of a U.S. patent. When performing a validity/invalidity search on a US patent the critical date is applied differently to different patent issuing authorities. Sub-option 203a allows the user to exclude references with dates that do not qualify for the search by defining the critical date as the priority date for U.S. patent and published application references, and as the publication date for foreign patent references. With the laws of various patent authorities included in the software, the user can accordingly select a critical date or range of dates to obtain the desired dates or dates in agreement with the respective country's patent laws and exclude those references that do not qualify based the user's definition of the critical date.

The fourth option 204 allows the user to reduce the results set in relation to the prior searching conducted by the user. In many instances during the course of a particular search, the same references are returned in the user's search queries depending on the keywords used, patent classifications, etc. By excluding references that have been identified by the user as previously reviewed, the user saves time by only reviewing new references in the results set. The previously reviewed references may be identified by any known visual or non-visual means, such as but not limited to highlighting. Further, the references may be identified in a specified manner and remain identified in that manner whenever they come up in a subsequent search string to alert the user to their status as previously reviewed.

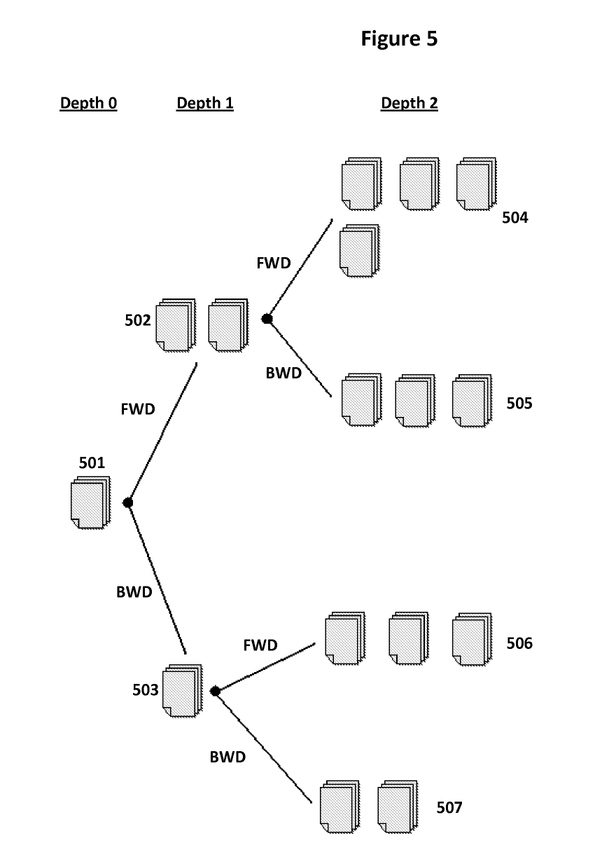

The fifth option 205 allows the user to expand the results set based on the desired level of depth of the FNB search. The user may select the number of times to recursively execute an FNB search in order to produce a results set of a desired size. For an FNB search of a depth of level 1 the search will compile the patents cited, citing patents, and/or cited non-patent literature for the target patent or group of patents. In the example illustrated in FIG. 5, the target patent 501 is located at Depth O. At Depth 1 the illustrated backward direction (hereinafter, BWD) points to reference 503 and forward direction (hereinafter, FWD) references 502 would create a results set of three references for a FNB search of a depth level of 1 for the target patent 501.

For an FNB search of a depth of level 2 the search will compile the patents cited, citing patents, and/or cited non-patent literature for all of the references in the level 1 results set and combine these results with the level 1 results. In the example illustrated in FIG. 5, at Depth 2 the references consist of the BWD references (505, 507) and FWD references (504, 506) for the references represented in Depth 1 (502, 503). The results set for an FNB search of a depth of level 2 for the target patent 501 would consist of the three references from Depth 1 and twelve references from Depth 2 for a total of fifteen references. This method may be recursively executed to compile the patents cited, citing patents, and/or cited non-patent literature in the same manner for increasing levels of depth. In addition, the user may also select any combination of the first through fourth options 201-204, sixth and seventh options 206-207, and sub-option 203a discussed above (i.e. Issuing authority selection, family member reduction, critical date selection, defining the critical date, previously-viewed reduction, keyword limiting, patent classification limiting options) to apply to this recursive, level-of-depth FNB search.

FIG. 7 is another illustration showing the Depth option of FNB process. In this illustration, we will consider patent 701 as the target patent to which an FNB search will be performed. As can be seen, a Depth 1 forward search (FWD) will return a two reference set consisting of 706, 707 and a Depth 1 backward search (BWD) will return a three reference set of 702, 703 & 704. It should be noted that the three references in the BWD set, 702, 703, & 704, are the references listed on the face of the target 701 in the References Cited field similar to field 401 and/or the Other Publications field similar to field 403 shown in FIG. 4. Additionally, a Depth 2 FNB search will return everything from Depth 1 in addition to three references set 708, 709 and 710 in the BWD direction along with three references set 711, 712 & 713 in the FWD direction. Therefore, performing a Depth 2 FNB search of target 701 will return a master FNB search results set of references 702-713. Although a depth search of only Depth 2 is demonstrated, this depth level can be incremented to tens, hundreds, thousands or even more depth levels.

The sixth option 206 allows the user to reduce the results set to only those references that contain a user defined keyword or keywords. The keyword or keywords may be entered by the user in conjunction with any known Boolean logical operators, such as but not limited to truncation characters, AND, OR, NOT, and proximity operators (near, with, adjacent, etc.) The user may also define the location within the document in which the keyword or keywords must appear, such as but not limited to the title, abstract, claims, detailed description, etc. With the option of limiting by keyword or keywords, the user increases the probability that the results set of the FNB search will contain references relevant to the subject of the patent search.

The seventh option 207 allows the user to reduce the results set to only those references that are classified in the user-identified patent classifications. The classifications may include classifications from any known patent issuing authority worldwide, such as but not limited to the classification systems employed by the United States, European, World Intellectual Property Organization, Japan, etc. Also, the patent classifications may be entered by the user in conjunction with any known Boolean logical operators, such as but not limited to truncation characters, AND, OR, etc. With the option of limiting by patent classifications, the user increases the probability that the results set of the FNB search will contain references relevant to the subject of the patent search.

The aforementioned options may also be used in any combination or used individually. For example, a user may want to limit the FNB citation search by a date range (203) as well as establish a particular family member hierarchy (202) or any other combination. In addition, options 201, 202, 203, 204, 206, 207 and sub-option 203a may be applicable to any patent search, not just an FNB search.

As illustrated in FIG. 1, the next step 104 in the method is executing an FNB search in an automated manner. Executing the FNB search in an automated manner includes but is not limited to the software compiling the patents cited, citing patents and/or cited non-patent literature for the target patent or group of patents, and manipulating the results set based on the options selected by the user in step 103 without additional action by the user. In the event that the target patent or group of patents includes pre-grant publications or another patent document that has other associated documents containing citation information, the step of compiling the results in an automated manner will also include retrieving citation information from any and/or all of the associated documents without additional action by the user.

The associated documents may include one or more of the following: Information Disclosure Statements (USPTO Form 1449), Notice of References Cited (USPTO Form 892) documents, Patent Cooperation Treaty (PCT) search reports, Japanese (JP) search reports, European (EP) search reports, or any other document associated with a patent or pre-grant publication containing citation information. This citation information from associated documents may be retrieved from the electronic file wrapper section of a U.S. patent application on the Public Patent Application Information Retrieval (PAIR) system, any other country's application system, any future Global or U.S. application system, or this related data may be purchased and added to any databases related to the present invention. By executing the FNB search in an automated manner the user saves time by eliminating the manual steps which would be required of the user to retrieve the citation information.

The final step 105 of the method is outputting the results set of an FNB search. The output of the results set may take an unlimited variety of forms which may be selected by the user. One such available output form is a listing of the citations of the results set in which the user may select any of the citations in the list to review the reference. Another available output form is a graphical representation of the results set in which the citations may be displayed in formats, such as but not limited to tables or graphs, and organized by information, such as but not limited to, priority date, inventor, assignee, issuing authority, image or any other relevant information.

Yet another available output form would be to identify the references from an FNB search results set in the results sets of subsequent search queries by the user. Patent searches usually have time constraints which result in circumstances where a user may not be able to narrow the results set of a search query down to a size where every reference can be reviewed by the user. Often the user will rely on the title names to alert them to the potential relevance of a reference. While titles are often helpful, it is also common in some art areas for titles to lack descriptive details or for a plurality of references to have the same title although the individual disclosures may be drawn to different aspects. An FNB search can assist in identifying potentially relevant references, but the user may not want to stop and do an FNB search for each relevant reference found. With the identifying output option, a user may elect to not have the FNB search results set produced and displayed for the user to review. Instead, the references that would be produced and displayed in the FNB search results set will be identified in subsequent search queries by another known means, including but not limited to highlighting, tagging, flagging or some other indicator, when those FNB results set references appear in the results sets of the subsequent search queries. This will let the user know that a reference in the subsequent search would have been produced and displayed in the FNB search results set if the user had elected to have them produce and displayed earlier. These identified FNB results set references produced by the subsequent search queries may prove to be highly relevant since not only are then being returned from the subsequent search query but they would also be returned in the FNB search results set of the target patent or group of patents, which the user already knows is highly relevant to the search being performed. The user will benefit in constrained time circumstances by having the identified FNB search results, as well as the reference titles, to alert the user to potentially relevant references for reviewing.

An additional output option when the user does not want to stop and review the results set of an FNB search is to send the FNB search results set into a new query for later review. A user may be focused on a particular search query and in the middle of reviewing the references with a certain perspective. To maintain continuity, the user may prefer to quickly perform an FNB search with annotations sent to a query for later review. In outputting the FNB search results set for later review, the user has the ability to manipulate the results set with any of the previously mentioned techniques, including but not limited to keywords or other search limiters, etc, at the time of output or later during review.

3. Preview FNB

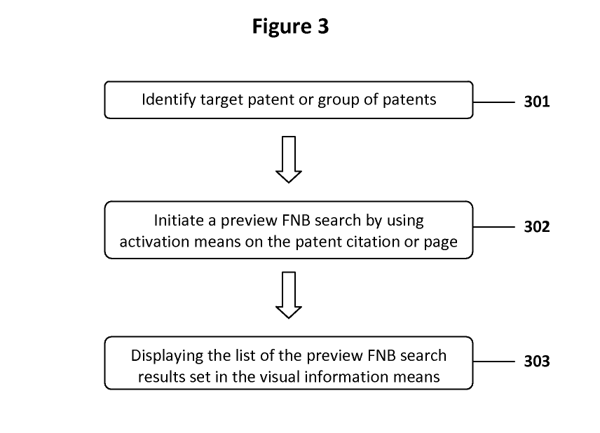

An additional preferred embodiment is illustrated in the flowchart of FIG. 3. In FIG. 3, the embodiment provides the advantage of previewing the list of citations in an unrestricted FNB search results set for a target patent or group of patents. The preview FNB provides the advantage of quickly allowing the user gauge characteristics of the FNB results set such as but limited to the size, most numerous issuing authorities, and/or approximate dates of the references in the results set. With this information the user can make an informed decision on whether to conduct an FNB search and which options, if any at all, will best manipulate the FNB search results to maximize efficiency in the user's patent search.

In the preview FNB search method, the first step 301 involves identifying the patents or group of patents on which the user would like to conduct an FNB search. Identifying the target patent or group of patents may includes but is not limited to selecting a check box next to the patent citations, clicking the patent citations, or any other known methods. The next step 302 involves using activation means in order to reveal visual information means, such as but not limited to an information box, menu, pane, etc. The visual information means will be used to show the information in the final step 303. The final step 303 outputs the results of the preview FNB search by displaying a list of the citations from the unrestricted results set for the target patent or group of patents. The unrestricted FNB search results set includes all of the references cited and citing references for the target patent or group of patents.

Although specific embodiments of the present invention have been illustrated and described herein, it will be appreciated by those of ordinary skill in the art that any arrangement which is calculated to achieve the same purpose may be substituted for the specific embodiments shown. In addition, although the above invention is demonstrated as a software based implementation, the invention could be implemented as software, hardware, or any combination foreseeable to one of ordinary skill in the art. This application is intended to cover any adaptations or variations within the spirit of the invention.

What is claimed is:

1) A method of searching an electronic patent database, comprising the steps of:
a) Providing access to a database of patent and pre-grant publication references, wherein each reference is associated with:
i) A list of citations for patent, pre-grant publication, and/or non-patent literature references cited by said reference;
ii) A list of patent and pre-grant publication references which cite said reference; and
b) Searching the database.

2) The method of searching the database of claim 1, further including the steps of:
a) Identifying a target patent or group of patents to be the subject of a forward and backward citation search (FNB search);
b) Initiating the FNB search for the target patent or group of patents;
c) Selecting from a plurality of options;
d) Executing an FNB search of the target patent or group of patents; and
e) Outputting the results of the FNB search.

3) The method of claim 2, wherein said step of initiating an FNB search for the target patent or group of patents further includes utilizing a menu.

4) The method of claim 3, wherein said menu further includes one selected from the group consisting of a drop down menu, a pop-up menu, a separate menu page, a separate window, or a side pane.

5) The method of claim 3, wherein said menu is revealed by activation means.

6) The method of claim 2, wherein said step of selecting from said plurality of options further includes user selectable options that will manipulate the number of references in the FNB search results set.

7) The method of claim 6, wherein one of said plurality of user selectable options is for which of the patent issuing authorities to include.

8) The method of claim 6, wherein one of said plurality of user selectable options is to retain only the highest priority patent family member or any other user defined patent family member.

9) The method claim 6, wherein one of said plurality of user selectable options is the exclusion of patents in relation to a critical date defined by the user.

10) The method of claim 9, wherein said critical date is defined by the user.

11) The method of claim 9, wherein the said critical date is the relevant date as defined by patent legislation or a patenting authority.

12) The method claim 6, wherein one of said plurality of user selectable options is the exclusion of patents in relation to a date range.

13) The method of claim 12, wherein said date range is defined by the user.

14) The method of claim 6, wherein one of said plurality of user selectable options is the exclusion of references identified as previously reviewed by the user.

15) The method of claim 6, wherein one of said plurality of user selectable options is the number of times or depth to recursively execute said FNB search of the references in the results set.

16) The method of claim 6, wherein one of the plurality of user selectable options is the exclusion of references not including the keyword or keywords defined by the user.

17) The method of claim 6, wherein one of said plurality of user selectable options is the exclusion of references not classified in the patent classifications identified by the user.

18) The method of claim 6, wherein said plurality of user selectable options may be selected in combination with any of the other user selectable options or individually.

19) The method of claim 2, wherein said step of executing an FNB search of the target patent or group of patents further includes executing the FNB search in an automated manner.

20) The method of claim 19, wherein said automated manner further includes compiling the patents cited, citing patents and cited non-patent literature citations for the target patent or group of patents into a results set without additional action by the user.

21) The method of claim 19, wherein said automated manner further includes retrieving citations information from documents associated with the target patents or group of patents without additional action by the user.

22) The method of claim 21, wherein said documents include any one or more of the following:
Information Disclosure Statements (USPTO Form 1449), Notice of References Cited (USPTO Form 892) documents, Patent Cooperation Treaty (PCT) search reports, Japanese (JP) search reports, European (EP) search reports.

23) The method of claim 2, wherein said step of outputting the results of the FNB search further includes a list of citations from which a user may select to review the reference.

24) The method of claim 2, wherein said step of outputting the results of the FNB search further includes a graphical representation of the references in the FNB search results set.

25) The method of claim 2, wherein said step of outputting the results of the FNB search further includes identifying citations from the FNB search results set in the results sets of subsequent search queries.

26) The method of claim 2, wherein said step of outputting the results of the FNB search further includes sending the results set to a separate search query for later review with or without further data manipulation or selection of said plurality of user selectable options.

27) A method of searching an electronic patent database, comprising the steps of:
a) Providing access to a database of patent and pre-grant publication references, wherein each reference is associated with:
i) A list of citations for patent, pre-grant publication, and/or non-patent literature references cited by said reference;
ii) A list of patent and pre-grant publication references which cite said reference;
b) Identifying a target patent or group of patents to be the subject of a forward and backward search (FNB search);
c) Initiating an FNB search for the target patent or group of patents and
d) Displaying a list of FNB search results set for the target patent or group of patents.

28) The method of claim 27, wherein said step of initiating an FNB search for the target patent or group of patents further includes using activation means on a citation or the page.

29) The method of claim 28, wherein the use of activation means reveals a visual information means.

30) The method of claim 29, wherein said visual information means displays the FNB search results.

31) The method of claim 27, wherein said FNB search results set further includes all citations for all references associated with the target patent or group of patents.
